(19) United States
(12) Patent Application Publication
(10) Pub. No.: US 2005/0154147 A1
(43) Pub. Date: Jul. 14, 2005

(54) Polyester compositions

(76) Inventors: Ted Calvin Germroth, Kingsport, TN (US); Rodney Layne Piner, Kingsport, TN (US); Candace Michele Tanner, Kingsport, TN (US)

Correspondence Address: B. J. Boshears;Eastman Chemical Company, P.O. Box 511, Kingsport, TN, 37662-5075, US

(21) Appl. No.: 10/998,910

(22) Filed: Nov. 29, 2004

Related U.S. Application Data
(60) Provisional application No. 60/531,658, filed on Dec. 22, 2003.

(51) Int. Cl. C08L 67/03

(52) U.S. Cl. 525/437

(57) ABSTRACT

Disclosed are polyester compositions having a glass transition temperature of less than about 10° C. comprising (A) at least one polyester comprising aromatic dicarboxylic acid residues and non-aromatic dicarboxylic acids; diols selected from the group consisting of aliphatic diols, polyalkylene ethers, and cycloaliphatic diols; and (B) a plasticizing effective amount of a compatible plasticizer.

### RELATED APPLICATIONS

This application claims the benefit of the following provisional application under 35 USC 119: Ser. No. 60/531,658, filed Dec. 22, 2003, incorporated herein by reference.

### FIELD OF THE INVENTION

This invention pertains to certain, novel polymer compositions. More specifically, this invention pertains to novel polymer compositions comprising certain biodegradable polyesters and plasticizers.

### BACKGROUND OF INVENTION

Polymeric materials are useful in replacing other materials for many end uses. Such materials provide a variety of properties identical to the substituted material, as well as, imparting additional, valuable properties. Chemical resistance, flexibility, and “feel” are some of these unique qualities. However, in some cases polymeric materials are not as flexible, nor have the desired feel, for their intended use. Polymers experience a transition known as the glass transition temperature or Tg. This temperature is usually recorded as the midpoint of a curve where a region of discontinuity occurs, as a function of temperature, in heat capacity, density, barrier, etc. At this temperature, polymers undergo a radical change in properties as a result of either an increase in molecular motion above this temperature, or a cessation in molecular motion below the temperature whereby the polymer becomes more rigid. In many cases where the Tg is only slightly above or below the room temperature the product is considered flexible. In general, the further the Tg is below room temperature the more flexible it will become. For products requiring polymers of higher flexibility and increased soft feel, a lower modulus can be achieved by lowering the Tg by two methods: the polymers either are designed with lower Tg by adjustment of the composition of the polymer, such as with polyethylene copolymers or an additive known as a plasticizer is added that can reduce the polymeric composition's Tg to suit the desired use temperature(s). When the Tg of a polymer is at or below normal environmental temperatures (−30* C. to 60* C.), it is typically thought that a need will not arise to further lower the Tg. However, further reduction of Tg may be desired, e.g., when (1) reinforcement, impact and/or extending additives have increased the modulus above product requirements; (2) the ambient use temperature and conditions are variable, as in the case of an all weather boot or shoe; (3) the polymeric material may be used exclusively at a temperature well below normal environmental temperature conditions; and (4) lowering the Tg imparts a greater feel of softness to a product at normal environmental temperature conditions.

Although polymers possessing inherently lower Tg's can be designed and prepared, in some cases the resulting polymer does not possess other important characteristics, for example, polymers possessing inherently lower Tg's may exhibit increased surface tackiness resulting in increased adhesion to surfaces. Consequently, articles made with this material will stick to themselves even to the point of coalescing in such a manner as to fuse the articles or films into one mass. One way to overcome this disadvantage is to increase the potential for crystals with melt temperatures well above the ambient use or storage or shipping temperature, to form on the surface thereby leaving a skin on the surface of the article, film or sheet that will not coalesce. Another way to overcome surface tackiness is to incorporate an “anti-blocking” additive, mineral or higher Tg polymer, that presents itself at the polymer surface, essentially providing a new surface on the film or article with the adhesion characteristics of the additive. Both of these methods will tend to increase the modulus, i.e., increase rigidity negating, in part, the desirable softness feel.

In the case of addition of a plasticizer to lower the Tg of polymeric materials, the desired effects are accomplished by the addition of a material of even lower Tg and/or higher mobility (generally a much lower molecular weight) than the polymer. A suitable or compatible plasticizer will:
(1) increase lubricity between polymer chains and chain ends by shielding intermolecular forces, thereby decreasing any three-dimensional interactions that form gel structures and preventing their reorganization, and, increasing the ability to slip by one another;
(2) increase the spacing between interacting chains, in effect, creating greater free volume that will allow a greater degree of freedom for rotation, reptilian motion, and oscillation of the chains and their ends and side chains;
(3) increase free volume by increasing the total number of end group contribution to the matrix.
(4) create a liquid state between the chains and involving the chains by the continuous salvation and desolvation of chains, and end-groups by the plasticizer;
(5) effect the formation of crystals either by increasing the potential to organize, or decrease it thereby reducing the modulus. See for example, Sears et al., The Technology of Plasticizers, Chapters 2 and 3, Wiley-Interscience Publications/John Wiley and Sons, Inc., (1982) and Encyclopedia of Polymer Science and Technology, Vol. 4, Jacqueline Kroschwitz, Executive Editor, Wiley-Interscience Publications/John Wiley and Sons, Inc., (2003).

Although the plasticization effects listed above are the most often mentioned in the literature, no single theory has been successfully applied to all interactions of the various plasticization agents with various polymers. With the advent of NMR, it has been discovered that the interactions are much more complex. Sears et al, The Technology of Plasticizers, provides an extensive explanation of the theories of plasticization and its mechanism.

For certain applications, e.g., tool handles, foot wear and sporting goods, an increased perception of softness and a greater range of flexibility may be desired to meet commercial requirements of the proposed end use.

### SUMMARY OF THE INVENTION

We have now found that the perceived softness and range of flexibility of certain polyesters having a Tg of less than about 10° C. can be improved by incorporating into such polyesters certain compatible plasticizer compounds. Thus, the present invention provides a polymer composition comprising: A polymer composition comprising:
(A) a copolyester having a glass transition temperature of less than about 10° C. and comprised of:
   (1) diacid residues comprising about 1 to 65 mole percent aromatic dicarboxylic acid residues; and 35 to about 99 mole percent of non-aromatic dicarboxylic acid residues selected from the group consisting of aliphatic dicarboxylic acids residues containing from about 4 to 14 carbon atoms and cycloaliphatic dicarboxylic acids residues containing from about 5 to 15 carbon atoms; wherein the total mole percent of diacid residues is equal to 100 mole percent; and
   (2) diol residues selected from the group consisting of one or more aliphatic diols containing about 2 to 8 carbon atoms, polyalkylene ethers containing about 2 to 8 carbon atoms, and cycloaliphatic diols containing from about 4 to 12 carbon atoms; wherein the total mole percent of diol residues is equal to 100 mole percent; and
(B) a plasticizing effective amount of one or more compatible plasticizers.

The polyesters of the invention surprisingly have an improved softness and greater range of flexibility provided that they have a Tg of less than about 10° C. and are combined with certain plasticizers.

### DETAILED DESCRIPTION OF THE INVENTION

This invention encompasses polymer compositions comprising:
(A) a copolyester having a glass transition temperature of less than about 10° C. and comprised of:
   (1) diacid residues comprising about 1 to 65 mole percent, preferably about 25 to 65 mole percent, more preferably 35 to 65 mole percent, and even more preferably, about 40 to 60 mole percent of aromatic dicarboxylic acid residues; and 99 to about 35 mole percent, preferably about 75 to 35 mole percent, and even more preferably, about 60 to 40 mole percent of non-aromatic dicarboxylic acid residues selected from the group consisting of aliphatic dicarboxylic acids residues containing from about 4 to 14 carbon atoms and cycloaliphatic dicarboxylic acids residues containing from about 5 to 15 carbon atoms; wherein the total mole percent of diacid residues is equal to 100 mole percent; and
   (2) diol residues selected from the group consisting of one or more aliphatic diols containing about 2 to 8 carbon atoms, polyalkylene ethers containing about 2 to 8 carbon atoms, and cycloaliphatic diols containing from about 4 to 12 carbon atoms; wherein the total mole percent of diol residues is equal to 100 mole percent; and
(B) a plasticizing effective amount of a compatible plasticizer. (lower Tg of the polymer)

Surprisingly, the present invention provides polymer blends exhibit an combination of improved softness and improved range of flexibility.

The copolyester useful in the invention are aliphatic-aromatic copolyesters referred to as AAPE herein) constituting component (1) of the present invention include those described in U.S. Pat. Nos. 5,661,193, 5,599,858, 5,580,911 and 5,446,079, the disclosures of which are incorporated herein by reference.

The copolyesters of the invention include those polymers having a glass transition temperature of less than −10° C. In other embodiments of the invention, the flexible biopolymers will have a glass transition temperature of less than about −20° C., and even more preferably, less than about −30° C.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The term “polyester”, as used herein, is intended to include “copolyesters” and is understood to mean a synthetic polymer prepared by the polycondensation of one or more difunctional carboxylic acids with one or more difunctional hydroxyl compounds. Typically the difunctional carboxylic acid is a dicarboxylic acid and the difunctional hydroxyl compound is a dihydric alcohol such as, for example, glycols and diols. The term “residue”, as used herein, means any organic structure incorporated into a polymer or plasticizer through a polycondensation reaction involving the corresponding monomer. The term “repeating unit”, as used herein, means an organic structure having a dicarboxylic acid residue and a diol residue bonded through a carbonyloxy group. Thus, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

The polyester(s) included in the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a copolyester containing 30 mole % adipic acid, based on the total acid residues, means that the copolyester contains 30 mole % adipic residues out of a total of 100 mole % acid residues. Thus, there are 30 moles of adipic residues among every 100 moles of acid residues. In another example, a copolyester containing 30 mole % 1,6-hexanediol, based on the total diol residues, means that the copolyester contains 30 mole % 1,6-hexanediol residues out of a total of 100 mole % diol residues. Thus, there are 30 moles of 1,6-hexanediol residues among every 100 moles of diol residues.

The polyesters of the invention typically exhibit a glass transition temperature (abbreviated herein as “Tg”) below 10 degrees C., as measured by well-known techniques such as, for example, differential scanning calorimetry (“DSC”). The polyesters utilized in the present invention preferably have glass transition temperatures of less than about 5° C., and more preferably, less than about 0° C.

The copolyester composition of this invention comprises an AAPE and a plasticizing effective amount of a compatible plasticizer. The AAPE may be a linear, random copolyester or branched and/or chain extended copolyester comprising diol residues which contain the residues of one or more substituted or unsubstituted, linear or branched, diols selected from aliphatic diols containing 2 to about 8 carbon atoms, polyalkylene ether glycols containing 2 to 8 carbon atoms, and cycloaliphatic diols containing about 4 to about 12 carbon atoms. The substituted diols, typically, will contain 1 to about 4 substituents independently selected from halo, C₆-C₁₀ aryl, and C₁-C₄ alkoxy. Examples of diols which may be used include, but are not limited to, ethylene glycol, diethylene glycol, propylene glycol, 1,3-propanediol, 2,2-dimethyl-1,3-propanediol, 1,3-butanediol, 1,4-butanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, triethylene glycol, and tetraethylene glycol. Aliphatic diols are preferred but not required. More preferred diols comprising one or more diols selected from 1,4-butanediol; 1,3-propanediol; ethylene glycol; 1,6-hexanediol; diethylene glycol; and 1,4-cyclohexanedimethanol. 1,4-butanediol, ethylene glycol and 1,4-cyclohexanedimethanol, singly, or in combination, are even more preferred, but not required.

The AAPE also comprises diacid residues which contain about 35 to about 99 mole %, based on the total moles of acid residues, of the residues of one or more substituted or unsubstituted, linear or branched, non-aromatic dicarboxylic acids selected from aliphatic dicarboxylic acids containing 2 to about 12 carbon atoms and cycloaliphatic dicarboxylic acids containing about 5 to about 10 carbon atoms. The substituted non-aromatic dicarboxylic acids will typically contain 1 to about 4 substituents selected from halo, C₆-C₁₀ aryl, and C₁-C₄ alkoxy. Non-limiting examples of aliphatic and cycloaliphatic dicarboxylic acids include malonic, succinic, glutaric, adipic, pimelic, azelaic, sebacic, fumaric, 2,2-dimethyl glutaric, suberic, 1,3-cyclopentanedicarboxylic, 1,4-cyclohexanedicarboxylic, 1,3-cyclohexanedicarboxylic, diglycolic, itaconic, maleic, and 2,5-norbornanedicarboxylic. In addition to the non-aromatic dicarboxylic acids, the AAPE comprises about 1 to about 65 mole %, based on the total moles of acid residues, of the residues of one or more substituted or unsubstituted aromatic dicarboxylic acids containing 6 to about 10 carbon atoms. In the case where substituted aromatic dicarboxylic acids are used, they will typically contain 1 to about 4 substituents selected from halo, C₆-C₁₀ aryl, and C₁-C₄ alkoxy. Non-limiting examples of aromatic dicarboxylic acids which may be used in the AAPE of our invention are terephthalic acid, isophthalic acid, salts of 5-sulfoisophthalic acid, and 2,6-naphthalenedicarboxylic acid. In another embodiment, the MPE comprises diol residues comprising the residues of one or more of: 1,4-butanediol; 1,3-propanediol; ethylene glycol; 1,6-hexanediol; diethylene glycol; or 1,4-cyclohexanedimethanol; and diacid residues comprising (i) about 35 to about 95 mole %, based on the total moles of acid residues, of the residues of one or more non-aromatic dicarboxylic acids selected from glutaric acid, diglycolic acid, succinic acid, 1,4-cyclohexanedicarboxylic acid, and adipic acid (preferably, glutaric acid and adipic acid, either singly or in combination); (ii) about 5 to about 65 mole %, based on the total moles of acid residues, of the residues of one or more aromatic dicarboxylic acids selected from terephthalic acid and isophthalic acid. More preferably, the non-aromatic dicarboxylic acid will comprise adipic acid, the aromatic dicarboxylic acid will comprise terephthalic acid, and the diol will comprise 1,4-butanediol.

Other preferred compositions for the AAPE's of the present invention are those prepared from the following diols and dicarboxylic acids (or copolyester-forming equivalents thereof such as diesters) in the following mole percent, based on 100 mole percent of a diacid component and 100 mole percent of a diol component:
(1) glutaric acid (about 30 to about 75%); terephthalic acid (about 25 to about 70%); 1,4-butanediol (about 90 to 100%); and modifying diol (0 about 10%);
(2) succinic acid (about 30 to about 95%); terephthalic acid (about 5 to about 70%); 1,4-butanediol (about 90 to 100%); and modifying diol (0 to about 10%); and
(3) adipic acid (about 30 to about 75%); terephthalic acid (about 25 to about 70%); 1,4-butanediol (about 90 to 100%); and modifying diol (0 to about 10%).

The modifying diol preferably is selected from 1,4-cyclohexanedimethanol, triethylene glycol, polyethylene glycol and neopentyl glycol. The most preferred AAPE's are linear, branched or chain extended copolyesters comprising about 50 to about 60 mole percent adipic acid residues, about 40 to about 50 mole percent terephthalic acid residues, and at least 95 mole percent 1,4-butanediol residues. Even more preferably, the adipic acid residues are from about 55 to about 60 mole percent, the terephthalic acid residues are from about 40 to about 45 mole percent, and the 1,4-butanediol residues are from about 95 to 100 mole percent. Such compositions are commercially available under the trademark Eastar Bio® copolyester from Eastman Chemical Company, Kingsport, Tenn.

Additional, specific examples of preferred AAPE's include a poly(tetra-methylene glutarate-co-terephthalate) containing (a) 50 mole percent glutaric acid residues, 50 mole percent terephthalic acid residues and 100 mole percent 1,4-butanediol residues, (b) 60 mole percent glutaric acid residues, 40 mole percent terephthalic acid residues and 100 mole percent 1,4-butanediol residues or (c) 40 mole percent glutaric acid residues, 60 mole percent terephthalic acid residues and 100 mole percent 1,4-butanediol residues; a poly(tetramethylene succinate-co-terephthalate) containing (a) 85 mole percent succinic acid residues, 15 mole percent terephthalic acid residues and 100 mole percent 1,4-butanediol residues or (b) 70 mole percent succinic acid residues, 30 mole percent terephthalic acid residues and 100 mole percent 1,4-butanediol residues; a poly(ethylene succinate-co-terephthalate) containing 70 mole percent succinic acid residues, 30 mole percent terephthalic acid residues and 100 mole percent ethylene glycol residues; and a poly(tetramethylene adipate-co-terephthalate) containing (a) 85 mole percent adipic acid residues, 15 mole percent terephthalic acid residues and 100 mole percent 1,4-butanediol residues or (b) 55 mole percent adipic acid residues, 45 mole percent terephthalic acid residues and 100 mole percent 1,4-butanediol residues.

The AAPE preferably comprises from about 10 to about 1,000 repeating units and preferably, from about 15 to about 600 repeating units. The MPE preferably also has an inherent viscosity of about 0.4 to about 2.0 dL/g, more preferably about 0.7 to about 1.4, as measured at a temperature of 25° C. using a concentration of 0.5 gram copolyester in 100 ml of a 60/40 by weight solution of phenol/tetrachloroethane.

The AAPE, optionally, may contain the residues of a branching agent. The weight percentage ranges for the branching agent are from about 0 to about 2 weight (wt % in this invention refers to weight %), preferably about 0.1 to about 1 wt %, and most preferably about 0.1 to about 0.5 wt % based on the total weight of the AAPE. The branching agent preferably has a weight average molecular weight of about 50 to about 5000, more preferably about 92 to about 3000, and a functionality of about 3 to about 6. For example, the branching agent may be the esterified residue of a polyol having 3 to 6 hydroxyl groups, a polycarboxylic acid having 3 or 4 carboxyl groups (or ester-forming equivalent groups) or a hydroxy acid having a total of 3 to 6 hydroxyl and carboxyl groups.

Representative low molecular weight polyols that may be employed as branching agents include glycerol, trimethylolpropane, trimethylolethane, polyethertriols, glycerol, 1,2,4-butanetriol, pentaerythritol, 1,2,6-hexanetriol, sorbitol, 1,1,4,4,-tetrakis(hydroxymethyl)cyclohexane, tris(2-hydroxyethyl)isocyanurate, and dipentaerythritol. Particular branching agent examples of higher molecular weight polyols (MW 400-3000) are triols derived by condensing alkylene oxides having 2 to 3 carbons, such as ethylene oxide and porpylene oxide with polyol initiators. Representative polycarboxylic acids that may be used as branching agents include hemimellitic acid, trimellitic (1,2,4-benzenetricarboxylic) acid and anhydride, trimesic (1,3,5-benzenetricarboxylic) acid, pyromellitic acid and anhydride, benzenetetracarboxylic acid, benzophenone tetracarboxylic acid, 1,1,2,2-ethanetetracarboxylic acid, 1,1,2-ethanetricarboxylic acid, 1,3,5-pentanetricarboxylic acid, and 1,2,3,4-cyclopentanetetracarboxylic acid. Although the acids may be used as such, preferably they are used in the form of their lower alkyl esters or their cyclic anhydrides in those instances where cyclic anhydrides can be formed. Representative hydroxy acids as branching agents include malic acid, citric acid, tartaric acid, 3-hydroxyglutaric acid, mucic acid, trihydroxyglutaric acid, 4-carboxyphthalic anhydride, hydroxyisophthalic acid, and 4-(beta-hydroxyethyl)phthalic acid. Such hydroxy acids contain a combination of 3 or more hydroxyl and carboxyl groups. Especially preferred branching agents include trimellitic acid, trimesic acid, pentaerythritol, trimethylol propane and 1,2,4-butanetriol.

The aliphatic-aromatic polyesters of the invention also may comprise one or more ion-containing monomers to increase their melt viscosity. It is preferred that the ion-containing monomer is selected from salts of sulfoisophthalic acid or a derivative thereof. A typical example of this type of monomer is sodiosulfoisophthalic acid or the dimethyl ester of sodiosulfoisophthalic. The preferred concentration range for ion-containing monomers is about 0.3 to about 5.0 mole %, and, more preferably, about 0.3 to about 2.0 mole %, based on the total moles of acid residues.

One example of a branched AAPE of the present invention is poly(tetramethylene adipate-co-terephthalate) containing 100 mole percent 1,4-butanediol residues, 43 mole percent terephthalic acid residues and 57 mole percent adipic acid residues and branched with about 0.5 weight percent pentaerythritol. This AAPE may be produced by the transesterification and polycondensation of dimethyl adipate, dimethyl terephthalate, pentaerythritol and 1,4-butanediol. The MPE may be prepared by heating the monomers at 190° C. for 1 hour, 200° C. for 2 hours, 210° C. for 1 hour, then at 250° C. for 1.5 hours under vacuum in the presence of 100 ppm of Ti present initially as titanium tetraisopropoxide.

Another example of a branched AAPE is poly(tetramethylene adipate-co-terephthalate) containing 100 mole percent 1,4-butanediol residues, 43 mole percent terephthalic acid residues and 57 mole percent adipic acid residues and branched with 0.3 weight percent pyromellitic dianhydride. This MPE is produced via reactive extrusion of linear poly(tetramethylene adipate-co-terephthalate) with pyromellitic dianhydride using an extruder.

The copolyester composition of the instant invention also may comprise from 0 to about 5 wt %, based on the total weight of the composition, of one or more chain extenders. Exemplary chain extenders are divinyl ethers such as those disclosed in U.S. Pat. No. 5,817,721 or diisocyanates such as, for example, those disclosed in U.S. Pat. No. 6,303,677. Representative divinyl ethers are 1,4-butanediol divinyl ether, 1,5-hexanediol divinyl ether and 1,4-cyclohexandimethanol divinyl ether.

Representative diisocyanates are toluene 2,4-diisocyanate, toluene 2,6-diisocyanate, 2,4′-diphenylmethane diisocyanate, naphthylene-1,5-diisocyanate, xylylene diisocyanate, hexamethylene diisocyanate, isophorone diisocyanate and methylenebis(2-isocyanatocyclohexane). The preferred diisocyanate is hexamethylene diisocyanate. The weight percent ranges are preferably about 0.3 to about 3.5 wt %, based on the total weight percent of the MPE, and most preferably about 0.5 to about 2.5 wt %. It is also possible in principle to employ trifunctional isocyanate compounds which may contain isocyanurate and/or biurea groups with a functionality of not less than three, or to replace the diisocyanate compounds partially by tri- or polyisocyanates.

The AAPE's of the instant invention are readily prepared from the appropriate dicarboxylic acids, esters, anhydrides, or salts, the appropriate diol or diol mixtures, and any branching agents using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein reactants are introduced and products withdrawn simultaneously in an uninterrupted manner. By “continuous” it is meant that the process is substantially or completely continuous in operation in contrast to a “batch” process. “Continuous” is not meant in any way to prohibit normal interruptions in the continuity of the process due to, for example, start-up, reactor maintenance, or scheduled shut down periods. The term “batch” process as used herein means a process wherein all the reactants are added to the reactor and then processed according to a predetermined course of reaction during which no material is fed or removed into the reactor. The term “semicontinuous” means a process where some of the reactants are charged at the beginning of the process and the remaining reactants are fed continuously as the reaction progresses. Alternatively, a semicontinuous process may also include a process similar to a batch process in which all the reactants are added at the beginning of the process except that one or more of the products are removed continuously as the reaction progresses. The process is operated advantageously as a continuous process for economic reasons and to produce superior coloration of the polymer as the copolyester may deteriorate in appearance if allowed to reside in a reactor at an elevated temperature for too long a duration.

The MPE's of the present invention are prepared by procedures known to persons skilled in the art and described, for example, in U.S. Pat. No. 2,012,267. Such reactions are usually carried out at temperatures from 150° C. to 300° C. in the presence of polycondensation catalysts such as, for example, alkoxy titanium compounds, alkali metal hydroxides and alcoholates, salts of organic carboxylic acids, alkyl tin compounds, metal oxides, and the like. The catalysts are typically employed in amounts between 10 to 1000 ppm, based on total weight of the reactants.

The reaction of the diol and dicarboxylic acid may be carried out using conventional copolyester polymerization conditions. For example, when preparing the copolyester by means of an ester interchange reaction, i.e., from the ester form of the dicarboxylic acid components, the reaction process may comprise two steps. In the first step, the diol component and the dicarboxylic acid component, such as, for example, dimethyl terephthalate, are reacted at elevated temperatures, typically, about 150° C. to about 250° C. for about 0.5 to about 8 hours at pressures ranging from about 0.0 kPa gauge to about 414 kPa gauge (60 pounds per square inch, “psig”). Preferably, the temperature for the ester interchange reaction ranges from about 180° C. to about 230° C. for about 1 to about 4 hours while the preferred pressure ranges from about 103 kPa gauge (15 psig) to about 276 kPa gauge (40 psig). Thereafter, the reaction product is heated under higher temperatures and under reduced pressure to form the AAPE with the elimination of diol, which is readily volatilized under these conditions and removed from the system. This second step, or polycondensation step, is continued under higher vacuum and a temperature which generally ranges from about 230° C. to about 350° C., preferably about 250° C. to about 310° C. and, most preferably, about 260° C. to about 290° C. for about 0.1 to about 6 hours, or preferably, for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reaction rates of both stages are increased by appropriate catalysts such as, for example, titanium tetrachloride, manganese diacetate, antimony oxide, dibutyl tin diacetate, zinc chloride, or combinations thereof. A three-stage manufacturing procedure, similar to that described in U.S. Pat. No. 5,290,631, may also be used, particularly when a mixed monomer feed of acids and esters is employed. For example, a typical aliphatic-aromatic copolyester, poly(tetramethylene glutarate-co-terephthalate) containing 30 mole percent terephthalic acid residues, may be prepared by heating dimethyl glutarate, dimethyl terephthalate, and 1,4-butanediol first at 200° C. for 1 hour then at 245° C. for 0.9 hour under vacuum in the presence of 100 ppm of Ti present initially as titanium tetraisopropoxide.

To ensure that the reaction of the diol component and dicarboxylic acid component by an ester interchange reaction is driven to completion, it is sometimes desirable to employ about 1.05 to about 2.5 moles of diol component to one mole dicarboxylic acid component. Persons of ordinary skill in the art will understand, however, that the ratio of diol component to dicarboxylic acid component is generally determined by the design of the reactor in which the reaction process occurs.

In the preparation of copolyester by direct esterification, i.e., from the acid form of the dicarboxylic acid component, polyesters are produced by reacting the dicarboxylic acid or a mixture of dicarboxylic acids with the diol component or a mixture of diol components and the branching monomer component. The reaction is conducted at a pressure of from about 7 kPa gauge (1 psig) to about 1379 kPa gauge (200 psig), preferably less than 689 kPa (100 psig) to produce a low molecular weight copolyester product having an average degree of polymerization of from about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction.

As used herein, the term “plasticizing effective amount” means that the amount of plasticizer is sufficient to have the effect of softening the polymer or lowering its Tg. The amount of plasticizer used in the copolyester composition is typically about 5 to about 40 weight %, based on the total weight percent of the copolyester. In one embodiment, the amount of plasticizer used in the copolyester composition is about 5 to about 20 weight %, based on the total weight percent of the copolyester.

As used herein, the term “compatible plasticizer” means that the plasticizer should be miscible with the MPE. The term “compatible plasticizer”, as used herein with plasticizer, is understood to mean that the plasticizer and the AAPE will mix together to form a stable mixture which will not rapidly separate into multiple phases under processing conditions or conditions of use although some exuding of the plasticizer is not uncommon. The industry describes this as blooming which refers to plasticizer slowly exuding from a compound (polymer+plasticizer+additives) over time where the bulk (majority) of the plasticizer remains in the compound under normal use conditions and in-use time. Thus, the term “compatible plasticizer” as used with plasticizer is intended to include both “soluble” mixtures, in which plasticizer and MPE form a true solution, and “compatible” mixtures, meaning that the mixture of plasticizer and AAPE do not necessarily form a true solution but only a stable blend. Generally, although not in all cases, the solubility parameter values of a solvent plasticizer fall within 2(cal/cc)^{1/2} of the value ascribed for the polymer itself. For plasticizers that a solubility parameter could not be determined for, the solubility is determined by observing the temperature at which the polymer is dissolved by the plasticizer forming a clear solution.

The copolyester composition also may comprise a phosphorus-containing flame retardant, although the presence of a flame retardant is not critical to the invention. The phosphorus-containing flame retardant should be miscible with the MPE. Preferably, the phosphorus-containing compound is a non-halogenated, organic compound such as, for example, a phosphorus acid ester containing organic substituents. The flame retardant may comprise a wide range of phosphorus compounds well-known in the art such as, for example, phosphines, phosphites, phosphinites, phosphonites, phosphinates, phosphonates, phosphine oxides, and phosphates. Examples of phosphorus-containing flame retardants include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine.

The flame retardant may be added to the copolyester composition at a concentration of about 5 weight % to about 40 weight % based on the total weight of the copolyester composition.

Oxidative stabilizers also may be included in the copolyester composition of the present invention to prevent oxidative degradation during processing of the molten or semi-molten material. Such stabilizers include esters such as distearyl thiodipropionate or dilauryl thiodipropionate; phenolic stabilizers such as IRGANOX® 1010 available from Ciba-Geigy AG, ETHANOX® 330 available from Ethyl Corporation, and butylated hydroxytoluene; and phosphorus containing stabilizers such as Irgafos® available from Ciba-Geigy AG and WESTON® stabilizers available from GE Specialty Chemicals. These stabilizers may be used alone or in combinations.

In addition, the copolyester composition may contain dyes, pigments, and processing aids such as, for example, fillers, matting agents, antiblocking agents, antistatic agents, blowing agents, chopped fibers, glass, impact modifiers, carbon black, talc, TiO2 and the like as desired. Colorants, sometimes referred to as toners, may be added to impart a desired neutral hue and/or brightness to the copolyester and the manufactured product. Representative examples of processing aids include calcium carbonate, talc, clay, TiO₂, NH₄Cl, silica, calcium oxide, sodium sulfate, and calcium phosphate. Further examples of processing aid levels within the copolyester composition of the instant invention are about 5 to about 25 wt % and about 10 to about 20 wt %. Preferably, the processing aid is also a biodegradation accelerant, that is, the processing aid increases or accelerates the rate of biodegradation in the environment. We have discovered that processing aids that also may function to alter the pH of the composting environment such as, for example, calcium carbonate, calcium hydroxide, calcium oxide, barium oxide, barium hydroxide, sodium silicate, calcium phosphate, magnesium oxide, and the like may also accelerate the biodegradation process. The copolyester compositions of the invention may contain biodegradable additives to enhance their disintegration and biodegradability in the environment. Representative examples of the biodegradable additives which may be included in the copolyester compositions of this invention include microcrystalline cellulose, polylactic acid, polyhydroxybutyrate, polyhydroxyvalerate, polyvinyl alcohol, thermoplastic starch or other carbohydrates, or combination thereof. Preferably, the biodegradable additive is a thermoplastic starch. A thermoplastic starch is a starch that has been gelatinized by extrusion cooking to impart a disorganized crystalline structure. As used herein, thermoplastic starch is intended to include “destructured starch” as well as “gelatinized starch”, as described, for example, in Bastioli, C. Degradable Polymers, 1995, Chapman & Hall: London, pages 112-137. By gelatinized, it is meant that the starch granules are sufficiently swollen and disrupted that they form a smooth viscous dispersion in the water. Gelatinization is effected by any known procedure such as heating in the presence of water or an aqueous solution at temperatures of about 60° C. The presence of strong alkali is known to facilitate this process. The thermoplastic starch may be prepared from any unmodified starch from cereal grains or root crops such as corn, wheat, rice, potato, and tapioca, from the amylose and amylopectin components of starch, from modified starch products such as partially depolymerized starches and derivatized starches, and also from starch graft copolymers. Thermoplastic starches are commercially available from National Starch Company.

By the term “biodegradable”, as used herein in reference to the AAPE's, copolyester compositions of this invention are degraded under environmental influences in an appropriate and demonstrable time span as defined, for example, by ASTM Standard Method, D6340-98, entitled “Standard Test Methods for Determining Aerobic Biodegradation of Radiolabeled Plastic Materials in an Aqueous or Compost Environment”. The AAPE's, copolyester compositions of the present invention also may be “biodisintegradable”, meaning that these materials are easily fragmented in a composting environment as determined by DIN Method 54900. The MPE, composition are initially reduced in molecular weight in the environment by the action of heat, water, air, microbes and other factors. This reduction in molecular weight results in a loss of physical properties (film strength) and often in film breakage. Once the molecular weight of the AAPE is sufficiently low, the monomers and oligomers are then assimilated by the microbes. In an aerobic environment, these monomers or oligomers are ultimately oxidized to CO₂, H₂O, and new cell biomass. In an anaerobic environment, the monomers or oligomers are ultimately oxidized to CO₂, H₂, acetate, methane, and cell biomass. Successful biodegradation requires that direct physical contact must be established between the biodegradable material and the active microbial population or the enzymes produced by the active microbial population. An active microbial population useful for degrading the films, copolyesters, and copolyester compositions of the invention can generally be obtained from any municipal or industrial wastewater treatment facility or composting facility. Moreover, successful biodegradation requires that certain minimal physical and chemical requirements be met such as suitable pH, temperature, oxygen concentration, proper nutrients, and moisture level.

The various components of the copolyester compositions such as, for example, the flame retardant, release additive, other processing aids, and toners, may be blended in batch, semicontinuous, or continuous processes. Small scale batches may be readily prepared in any high-intensity mixing devices well-known to those skilled in the art, such as Banbury mixers, prior to calendering or other thermal processing. The components also may be blended in solution in an appropriate solvent. The melt blending method includes blending the copolyester, additive, and any additional non-polymerized components at a temperature sufficient to at least partially melt the copolyester. The blend may be cooled and pelletized for further use or the melt blend can be processed directly from this molten blend into film, sheet or molded article, for example. The term “melt” as used herein includes, but is not limited to, merely softening the AAPE. For melt mixing methods generally known in the polymer art, see “Mixing and Compounding of Polymers” (I. Manas-Zloczower & Z. Tadmor editors, Carl Hanser Verlag Publisher, 1994, New York, N.Y.). When colored product (e.g. sheet, molded article or film) is desired, pigments or colorants may be included in the copolyester coposition during the reaction of the diol and the dicarboxylic acid or they may be melt blended with the preformed copolyester. A preferred method of including colorants is to use a colorant having thermally stable organic colored compounds having reactive groups such that the colorant is copolymerized and incorporated into the copolyester to improve its hue. For example, colorants such as dyes possessing reactive hydroxyl and/or carboxyl groups, including, but not limited to, blue and red substituted anthraquinones, may be copolymerized into the polymer chain. When dyes are employed as colorants, they may be added to the copolyester reaction process after an ester interchange or direct esterification reaction.

The polymer compositions of the invention comprise a plasticizer combined with a polymer as described herein. The presence of the plasticizer is useful to enhance flexibility and the good mechanical properties of the resultant film or sheet or molded object. The plasticizer also helps to lower the processing temperature of the polyesters. The plasticizers typically comprise one or more aromatic rings. The preferred plasticizers are soluble in the polyester as indicated by dissolving a 5-mil (0.127 mm) thick film of the polyester to produce a clear solution at a temperature of 160° C. or less. More preferably, the plasticizers are soluble in the polyester as indicated by dissolving a 5-mil (0.127 mm) thick film of the polyester to produce a clear solution at a temperature of 150° C. or less. The solubility of the plasticizer in the polyester may be determined as follows:
1. Placing into a small vial a 1/2 inch section of a standard reference film, 5 mils (0.127 mm) in thickness and about equal to the width of the vial.
2. Adding the plasticizer to the vial until the film is covered completely.
3. Placing the vial with the film and plasticizer on a shelf to observe after one hour and again at 4 hours. Note the appearance of the film and liquid.
4. After the ambient observation, placing the vial in a heating block and allow the temperature to remain constant at 75° C. for one hour and observe the appearance of the film and liquid.
5. Repeating step 4 for each of the following temperatures (° C.): 100, 140, 150, and 160.

Examples of plasticizers potentially useful in the invention are as follows. While some of these plasticizers are compatible with the polyester compositions of the invention, it is not expected that all of them are compatible:

TABLE A
Plasticizers

Adipic Acid Derivatives
Dicapryl adipate
Di-(2-ethylhexyl adipate)
Di(n-heptyl, n-nonyl) adipate
Diisobutyl adipate
Diisodecyl adipate
Dinonyl adipate
Di-(tridecyl) adipate
Azelaic Acid Derivatives
Di-(2-ethylhexyl azelate)
Diisodecyl azelate
Diisoctyl azealate
Dimethyl azelate
Di-n-hexyl azelate
Benzoic Acid Derivatives
Diethylene glycol dibenzoate (DEGDB)
Dipropylene glycol dibenzoate
Propylene glycol dibenzoate
Polyethylene glycol 200 dibenzoate
Neopentyl glycol dibenzoate
Citric Acid Derivatives
Acetyl tri-n-butyl citrate
Acetyl triethyl citrate
Tri-n-Butyl citrate
Triethyl citrate
Dimer Acid Derivatives
Bis-(2-hydroxyethyl dimerate)
Epoxy Derivatives
Epoxidized linseed oil
Epoxidized soy bean oil
2-Ethylhexyl epoxytallate
Fumaric Acid Derivatives
Dibutyl fumarate
Glycerol Derivatives
Glycerol Tribenzoate
Glycerol triacetate
Glycerol diacetate monolaurate
Isobutyrate Derivative
2,2,4-Trimethyl-1,3-pentanediol,
Diisobutyrate
Texanol diisobutyrate
Isophthalic Acid Derivatives
Dimethyl isophthalate
Diphenyl isophthalate
Di-n-butylphthalate
Lauric Acid Derivatives
Methyl laurate
Linoleic Acid Derivative
Methyl linoleate, 75%
Maleic Acid Derivatives
Di-(2-ethylhexyl) maleate
Di-n-butyl maleate
Mellitates
Tricapryl trimellitate
Triisodecyl trimellitate
Tri-(n-octyl,n-decyl) trimellitate
Triisonyl trimellitate
Myristic Acid Derivatives
Isopropyl myristate
Oleic Acid Derivatives
Butyl oleate
Glycerol monooleate
Glycerol trioleate
Methyl oleate
n-Propyl oleate
Tetrahydrofurfuryl oleate
Palmitic Acid Derivatives
Isopropyl palmitate
Methyl palmitate
Paraffin Derivatives
Chloroparaffin, 41% C1
Chloroparaffin, 50% C1
Chloroparaffin, 60% C1
Chloroparaffin, 70% C1
Phosphoric Acid Derivatives
2-Ethylhexyl diphenyl phosphate
Isodecyl diphenyl phosphate
t-Butylphenyl diphenyl phosphate
Resorcinol bis(diphenyl phosphate) (RDP)
100% RDP
Blend of 75% RDP, 25% DEGDB (by wt)
Blend of 50% RDP, 50% DEGDB (by wt)
Blend of 25% RDP, 75% DEGDB (by wt)
Tri-butoxyethyl phosphate
Tributyl phosphate
Tricresyl phosphate
Triphenyl phosphate
Phthalic Acid Derivatives
Butyl benzyl phthalate
Texanol benzyl phthalate
Butyl octyl phthalate
Dicapryl phthalate
Dicyclohexyl phthalate
Di-(2-ethylhexyl) phthalate
Diethyl phthalate
Dihexyl phthalate
Diisobutyl phthalate
Diisodecyl phthalate
Diisoheptyl phthalate
Diisononyl phthalate
Diisooctyl phthalate
Dimethyl phthalate
Ditridecyl phthalate
Diundecyl phthalate
Ricinoleic Acid Derivatives
Butyl ricinoleate
Glycerol tri(acetyl) ricinlloeate
Methyl acetyl ricinlloeate
Methyl ricinlloeate
n-Butyl acetyl ricinlloeate
Propylene glycol ricinlloeate
Sebacic Acid Derivatives
Dibutyl sebacate
Di-(2-ethylhexyl) sebacate
Dimethyl sebacate
Stearic Acid Derivatives
Ethylene glycol monostearate
Glycerol monostearate
Isopropyl isostearate
Methyl stearate
n-Butyl stearate
Propylene glycol monostearate
Succinic Acid Derivatives
Diethyl succinate
Sulfonic Acid Derivatives
N-Ethyl o,p-toluenesulfonamide
o,p-toluenesulfonamide

A similar test to that above is described in The Technology of Plasticizers, by J. Kern Sears and Joseph R. Darby, published by Society of Plastic Engineers/Wiley and Sons, New York, 1982, pp 136-137. In this test, a grain of the polymer is placed in a drop of plasticizer on a heated microscope stage. If the polymer disappears, then it is solubilized. The plasticizers can also be classified according to their solubility parameter. The solubility parameter, or square root of the cohesive energy density, of a plasticizer can be calculated by the method described by Coleman et al., Polymer 31, 1187 (1990). It is generally understood that the solubility parameter of the plasticizer should be within 2.0 units of the solubility parameter of the polyester, preferably less than 1.5 unit of the solubility parameter of the polyester, and more preferably, less than 1.0 unit of the solubility parameter of the polyester.

Examples of plasticizers which may be used according to the invention are esters comprising: (i) acid residues comprising one or more residues of: phthalic acid, adipic acid, trimellitic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms. Further, non-limiting examples of alcohol residues of the plasticizer include methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol. The plasticizer also may comprise one or more benzoates, phthalates, phosphates, or isophthalates.

In one embodiment, the preferred plasticizers are selected from the group consisting of N-ethyl-o,p-toluenesulfonamide, 2-ethylhexyl diphenyl phosphate, isodecyl diphenyl phosphate, tributyl phosphate, t-butylphenyl diphenyl phosphate, tricresyl phosphate, chloroparaffin (60% chlorine), chloroparaffin (50% chlorine), diethyl succinate, di-n-butyl maleate, di-(2-ethylhexyl) maleate, n-butyl stearate, acetyl triethyl citrate, triethyl citrate, tri-n-butyl citrate, acetyl tri-n-butyl citrate, methyl oleate, dibutyl fumarate, diisobutyl adipate, dimethyl azelate, epoxidized linseed oil, glycerol monooleate, methyl acetyl ricinloeate, n-butyl acetyl ricinloeate, propylene glycol ricinloeate, polyethylene glycol 200 dibenzoate, diethylene glycol dibenzoate, dipropylene glycol dibenzoate, dimethyl phthalate, diethyl phthalate, di-n-butylphthalate, diisobutyl phthalate, butyl benzyl phthalate, and glycerol triacetate.

In a second embodiment, the preferred plasticizers are selected from the group consisting of N-ethyl-o,p-toluenesulfonamide, 2-ethylhexyl diphenyl phosphate, isodecyl diphenyl phosphate, tributyl phosphate, t-butylphenyl diphenyl phosphate, tricresyl phosphate, chloroparaffin (60% chlorine), chloroparaffin (50% chlorine), diethyl succinate, di-n-butyl maleate, di-(2-ethylhexyl) maleate, n-butyl stearate, acetyl triethyl citrate, triethyl citrate, tri-n-butyl citrate, dimethyl azelate, polyethylene glycol 200 dibenzoate, diethylene glycol dibenzoate, dipropylene glycol dibenzoate, dimethyl phthalate, diethyl phthalate, di-n-butylphthalate, diisobutyl phthalate, butyl benzyl phthalate, or glycerol triacetate.

In a third embodiment, the preferred plasticizers are selected from the group consisting of N-ethyl-o,p-toluenesulfonamide, 2-ethylhexyl diphenyl phosphate, isodecyl diphenyl phosphate, t-butylphenyl diphenyl phosphate, tricresyl phosphate, chloroparaffin (60% chlorine), chloroparaffin (50% chlorine), diethyl succinate, di-n-butyl maleate, n-butyl stearate, polyethylene glycol 200 dibenzoate, diethylene glycol dibenzoate, dipropylene glycol dibenzoate, dimethyl phthalate, diethyl phthalate, di-n-butylphthalate, diisobutyl phthalate, or butyl benzyl phthalate.

In a fourth embodiment, the preferred plasticizers are selected from the group consisting of N-ethyl-o,p-toluenesulfonamide, 2-ethylhexyl diphenyl phosphate, isodecyl diphenyl phosphate, t-butylphenyl diphenyl phosphate, tricresyl phosphate, chloroparaffin (60% chlorine), polyethylene glycol 200 dibenzoate, diethylene glycol dibenzoate, dipropylene glycol dibenzoate, dimethyl phthalate, diethyl phthalate, di-n-butylphthalate, or butyl benzyl phthalate.

In a fifth embodiment, the preferred plasticizers are selected from the group consisting of N-ethyl-o,p-toluenesulfonamide, t-butylphenyl diphenyl phosphate, tricresyl phosphate, diethylene glycol dibenzoate, dipropylene glycol dibenzoate, dimethyl phthalate, diethyl phthalate, or butyl benzyl phthalate.

In a sixth embodiment, the preferred plasticizers are selected from the group consisting of N-ethyl-o,p-toluenesulfonamide, diethylene glycol dibenzoate, dipropylene glycol dibenzoate, or dimethyl phthalate.

In a seventh embodiment, diethylene glycol dibenzoate is the preferred plasticizer.

The novel polymer compositions preferably contain a phosphorus catalyst quencher component (C), typically one or more phosphorus compounds such as a phosphorus acid, e.g., phosphoric and/or phosphorous acids, or an ester of a phosphorus acid such as a phosphate or phosphite ester. Further examples of phosphorus catalyst quenchers are described in U.S. Pat. Nos. 5,907,026 and 6,448,334. The amount of phosphorus catalyst quencher present typically provides an elemental phosphorus content of about 0 to 0.5 weight percent, preferably 0.05 to 0.3 weight percent, based on the total weight of (A) and (B).

The novel polymer compositions preferably contain a phosphorus catalyst quencher component (C), typically one or more phosphorus compounds such as a phosphorus acid, e.g., phosphoric and/or phosphorous acids, or an ester of a phosphorus acid such as a phosphate or phosphite ester. Further examples of phosphorus catalyst quenchers are described in U.S. Pat. Nos. 5,907,026 and 6,448,334. The amount of phosphorus catalyst quencher present typically provides an elemental phosphorus content of about 0 to 0.5 weight percent, preferably 0.05 to 0.3 weight percent, based on the total weight of polyestercarbonate (A) and polyester (A)ₙ.

The polyester composition may also be formed into film, molded items or sheet using many methods known to those skilled in the art, including but not limited to extrusion, injection molding, extrusion molding and calendaring. In the extrusion process, the polyesters, typically in pellet form, are mixed together in a tumbler and then placed in a hopper of an extruder for melt compounding. Alternatively, the pellets may be added to the hopper of an extruder by various feeders, which meter the pellets in their desired weight ratios. Upon exiting the extruder the now homogenous copolyester blend is shaped into a film or molded item. The shape of the film or molded item is not restricted in any way. For example, a film may be a flat sheet or a tube. The film obtained may be stretched, for example, in a certain direction by from 2 to 6 times the original measurements.

The stretching method for the film may be by any of the methods known in the art, such as, the roll stretching method, the long-gap stretching, the tenter-stretching method, and the tubular stretching method. With the use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also the stretching may be done first in one direction and then in the other direction to result in effective biaxial stretching. The polymer compositons also exhibit increase in softness, scratch resistance and reduced surface tackiness.

In some embodiments, a process is disclosed for making such articles, film, sheet, and/or fibers comprising the steps of injection molding, extrusion blow molding, film/sheet extruding or calendering the polymer compositions(s) of the invention.

The present invention is illustrated in greater detail by the specific examples presented below. It is to be understood that these examples are illustrative embodiments and are not intended to be limiting of the invention, but rather are to be construed broadly within the scope and content of the appended claims.

### EXAMPLES

A variety of compounds were evaluated for plasticizer activity using as the component (1) a copolyester containing 44 mole % terephthalic acid, 56 mole % adipic acid, and 100 mole % of 1,4-butanediol, known as EASTAR™ BIO copolyester, formerly available from Eastman Chemical Company, having a Tg of approximately −35° C. and a crystal melt of ˜115° C. Preferred plasticizers dissolve a film of the polyester to produce a clear solution at temperatures below about 160° C. This property of the plasticizer is referred to as its solubility. The procedure for determining whether a test compound is a suitable plasticizer for the component (1) copolyesters consisted of placing a 1.77×1.77 cm (0.5×0.5 inch) square sample of copolyester film having a thickness of 25 micron (1 mil) in a small vial. The test compound was added to cover the film. The film was observed at room temperature (RT) after one-hour and four hours for obvious changes in the film. The film then was placed in a test tube heating block and the temperature was raised and observed after one-hour and four hours similar to the room temperature sample at the following temperatures; 40, 50, 60, 70, 80, 90, 100, and 110° C. This temperature change encompasses the range from room temperature to near the peak crystalline melting point of the copolyester. The appearance of the polymer and vial contents at the end of each period at each temperature used in the evaluation were rated numerically according to the following scale:
0=plasticizer is liquid, yet no apparent change to the film
1=film is clearing (film was originally hazy)
2=film has fully cleared
3=film has lost stiffness and can no longer stand in vial
4=film has lost structure; polymer is a mass in bottom of vial
5=film/polymer is dispersing and dissolving
6=liquid is hazy, no polymer noticeable
7=liquid is clear

In order for a test compound to be considered a component (2) plasticizer, the test compound typically should have a value of 4 at a temperature of 110° or less, wherein a film of the AAPE copolyester is converted to a shapeless mass of copolyester. Grading the test compounds as to an order that can predict more efficient solvent character of the plasticizer for the copolyester may be done by noting the lowest temperature where 7 is observed followed by 6 then 5. Table I is as follows:

TABLE 1

| | Temperature of Test, ° C. | | | | | | | | |
|---|---|---|---|---|---|---|---|---|---|
| | RT | 40 | 50 | 60 | 70 | 80 | 90 | 100 | 110 |
| Dicapryl adipate | 0 | 0 | 0 | 0 | 0 | 0 | 0 | 0 | 0 |
| Di-(2-ethylhexyl adipate) | 0 | 0 | 0 | 0 | 0 | 0 | 0 | 0 | 0 |
| Di(n-heptyl, n-nonyl) | 0 | 0 | 0 | 0 | 0 | 0 | 0 | 0 | 0 |
| adipate | | | | | | | | | |
| Diisobutyl adipate | 0 | 0 | 0 | 0 | 0 | 0 | 0 | 3 | 4 |
| Diisodecyl adipate | 0 | 0 | 0 | 0 | 0 | 0 | 0 | 0 | 0 |
| Dinonyl adipate | 0 | 0 | 0 | 0 | 0 | 0 | 0 | 0 | 0 |
| Di-(tridecyl) adipate | 0 | 0 | 0 | 0 | 0 | 0 | 0 | 0 | 0 |
| Di-(2-ethylhexyl azelate) | 0 | 0 | 0 | 0 | 0 | 0 | 0 | 0 | 0 |
| Diisodecyl azelate | 0 | 0 | 0 | 0 | 0 | 0 | 0 | 0 | 0 |
| Diisoctyl azealate | 0 | 0 | 0 | 0 | 0 | 0 | 0 | 0 | 0 |
| Dimethyl azelate | 0 | 0 | 0 | 0 | 6 | 6 | 6 | 6 | 6 |
| Di-n-hexyl azelate | 0 | 0 | 0 | 0 | 0 | 0 | 0 | 0 | 0 |
| Diethylene glycol | 0 | 2 | 2 | 6 | 7 | 7 | 7 | 7 | 7 |
| dibenzoate | | | | | | | | | |
| Dipropylene glycol | 0 | 2 | 5 | 7 | 7 | 7 | 7 | 7 | 7 |
| dibenzoate | | | | | | | | | |
| Polyethylene glycol | 0 | 1 | 2 | 2 | 2 | 2 | 7 | 7 | 7 |
| 200 dibenzoate | | | | | | | | | |
| Acetyl tri-n-butyl citrate | 0 | 0 | 1 | 1 | 1 | 1 | 1 | 3 | 4 |
| Acetyl triethyl citrate | 0 | 0 | 0 | 0 | 0 | 0 | 3 | 6 | 6 |
| Tri-n-Butyl citrate | 0 | 0 | 0 | 0 | 0 | 0 | 3 | 6 | 6 |
| Triethyl citrate | 0 | 0 | 0 | 0 | 0 | 5 | 6 | 6 | 6 |
| Bis- | 0 | 0 | 0 | 0 | 0 | 0 | 0 | 0 | 3 |
| (2-hydroxyethyl)dimerate | | | | | | | | | |
| Epoxidized linseed oil | 0 | 0 | 0 | 0 | 0 | 0 | 0 | 0 | 4 |
| Epoxidized soy bean oil | 0 | 0 | 1 | 1 | 1 | 1 | 1 | 1 | 3 |
| 2-Ethylhexyl epoxytallate | 0 | 0 | 0 | 0 | 0 | 0 | 3 | 3 | 3 |
| Dibutyl fumarate | 0 | 0 | 0 | 0 | 0 | 0 | 3 | 4 | 4 |
| Glycerol triacetate | 0 | 0 | 0 | 0 | 0 | 3 | 6 | 6 | 6 |
| 2,2,4-Trimethyl-1,3- | 0 | 0 | 0 | 0 | 0 | 0 | 1 | 3 | 3 |
| pentanediol, | | | | | | | | | |
| Diisobutyrate | | | | | | | | | |
| Di-n-butylphthalate | 0 | 0 | 1 | 1 | 1 | 3 | 7 | 7 | 7 |
| Methyl laurate | 0 | 0 | 0 | 0 | 0 | 0 | 0 | 3 | 3 |
| Methyl linoleate, 75% | 0 | 0 | 0 | 0 | 0 | 1 | 1 | 3 | 3 |
| Di-(2-ethylhexyl) | 0 | 0 | 0 | 0 | 0 | 1 | 1 | 1 | 6 |
| maleate | | | | | | | | | |
| Di-n-butyl maleate | 0 | 0 | 0 | 0 | 0 | 3 | 6 | 7 | 7 |
| Tricapryl trimellitate | 0 | 0 | 0 | 0 | 0 | 0 | 0 | 0 | 0 |
| Triisodecyl trimellitate | 0 | 0 | 0 | 0 | 0 | 0 | 1 | 1 | 2 |
| Tri-(n-octyl,n-decyl) | 0 | 0 | 1 | 1 | 1 | 1 | 1 | 1 | 1 |
| trimellitate | | | | | | | | | |
| Triisonyl trimellitate | 0 | 0 | 0 | 0 | 0 | 1 | 1 | 1 | 1 |
| Isopropyl myristate | 0 | 0 | 0 | 0 | 1 | 1 | 1 | 3 | 3 |
| Butyl oleate | 0 | 0 | 0 | 0 | 0 | 0 | 0 | 0 | 0 |
| Glycerol monooleate | 0 | 0 | 0 | 0 | 0 | 0 | 0 | 0 | 4 |
| Glycerol trioleate | 0 | 0 | 0 | 0 | 0 | 1 | 1 | 1 | 1 |
| Methyl oleate | 0 | 0 | 0 | 0 | 0 | 1 | 1 | 1 | 5 |
| n-Propyl oleate | 0 | 0 | 0 | 0 | 0 | 0 | 1 | 1 | 3 |
| Tetrahydrofurfuryl oleate | 0 | 0 | 0 | 0 | 0 | 0 | 1 | 1 | 3 |
| Isopropyl palmitate | 0 | 0 | 0 | 0 | 0 | 0 | 1 | 1 | 1 |
| Chloroparaffin, 41% C1 | 0 | 0 | 0 | 0 | 0 | 2 | 2 | 2 | 2 |
| Chloroparaffin, 50% C1 | 0 | 0 | 0 | 0 | 1 | 6 | 6 | 7 | 7 |
| Chloroparaffin, 60% C1 | 0 | 5 | 6 | 6 | 6 | 6 | 7 | 7 | 7 |
| 2-Ethylhexyl diphenyl | 0 | 1 | 1 | 1 | 1 | 5 | 7 | 7 | 7 |
| phosphate | | | | | | | | | |
| Isodecyl diphenyl | 0 | 0 | 0 | 0 | 1 | 2 | 7 | 7 | 7 |
| phosphate | | | | | | | | | |
| t-Butylphenyl diphenyl | 0 | 1 | 1 | 1 | 2 | 7 | 7 | 7 | 7 |
| phosphate | | | | | | | | | |
| Tri-butoxyethyl | 0 | 0 | 0 | 0 | 0 | 1 | 3 | 3 | 3 |
| phosphate | | | | | | | | | |
| Tributyl phosphate | 0 | 0 | 0 | 0 | 0 | 1 | 3 | 6 | 6 |
| Tricresyl phosphate | 0 | 1 | 2 | 2 | 2 | 7 | 7 | 7 | 7 |
| Butyl benzyl phthalate | 0 | 0 | 1 | 1 | 5 | 7 | 7 | 7 | 7 |
| Butyl octyl phthalate | 0 | 0 | 0 | 1 | 1 | 1 | 2 | 3 | 3 |
| Dicapryl phthalate | 0 | 0 | 0 | 0 | 0 | 0 | 0 | 0 | 3 |
| Di-(2-ethylhexyl) | 0 | 0 | 0 | 0 | 1 | 1 | 1 | 1 | 3 |
| phthalate | | | | | | | | | |
| Diethyl phthalate | 0 | 2 | 2 | 2 | 6 | 7 | 7 | 7 | 7 |
| Dihexyl phthalate | 0 | 0 | 0 | 0 | 0 | 1 | 3 | 3 | 3 |
| Diisobutyl phthalate | 0 | 0 | 0 | 0 | 2 | 2 | 6 | 7 | 7 |
| Diisodecyl phthalate | 0 | 0 | 0 | 0 | 0 | 0 | 0 | 1 | 1 |
| Diisoheptyl phthalate | 0 | 0 | 0 | 0 | 0 | 0 | 0 | 0 | 0 |
| Diisononyl phthalate | 0 | 0 | 0 | 0 | 0 | 0 | 0 | 0 | 3 |
| Diisooctyl phthalate | 0 | 0 | 0 | 0 | 1 | 1 | 2 | 2 | 3 |
| Dimethyl phthalate | 0 | 2 | 2 | 7 | 7 | 7 | 7 | 7 | 7 |
| Ditridecyl phthalate | 0 | 0 | 0 | 0 | 0 | 0 | 0 | 0 | 0 |
| Diundecyl phthalate | 0 | 0 | 0 | 0 | 0 | 0 | 0 | 0 | 0 |
| Butyl ricinoleate | 0 | 0 | 0 | 0 | 0 | 0 | 0 | 0 | 3 |
| Glycerol tri(acetyl) | 0 | 0 | 0 | 0 | 0 | 0 | 0 | 0 | 0 |
| ricinloeate | | | | | | | | | |
| Methyl acetyl ricinloeate | 0 | 0 | 0 | 0 | 0 | 0 | 0 | 3 | 4 |
| Methyl ricinloeate | 0 | 0 | 0 | 0 | 0 | 0 | 0 | 3 | 3 |
| n-Butyl acetyl ricinloeate | 0 | 0 | 0 | 0 | 0 | 0 | 0 | 0 | 4 |
| Propylene glycol | 0 | 0 | 0 | 0 | 0 | 0 | 0 | 0 | 4 |
| ricinloeate | | | | | | | | | |
| Dibutyl sebacate | 0 | 0 | 0 | 0 | 0 | 0 | 0 | 0 | 3 |
| Di-(2-ethylhexyl) | 0 | 0 | 0 | 0 | 0 | 0 | 0 | 0 | 0 |
| sebacate | | | | | | | | | |
| Isopropyl isostearate | 0 | 0 | 0 | 0 | 0 | 0 | 0 | 0 | 0 |
| n-Butyl stearate | 0 | 0 | 0 | 0 | 0 | 0 | 0 | 7 | 7 |
| Diethyl succinate | 0 | 0 | 0 | 6 | 6 | 6 | 6 | 7 | 7 |
| N-Ethyl | 0 | 5 | 7 | 7 | 7 | 7 | 7 | 7 | 7 |
| o,p-toluenesulfonamide | | | | | | | | | |

Grading the test compounds as to their efficiency as plasticizers can be done by noting the lowest temperature where a rating of 7 is observed followed by 6 then a 5 rating. Selection preferences can be altered to also consider such issues as cost, health, and safety. Based on the above described test procedures, the preferred plasticizers comprise N-ethyl-o,p-toluenesulfonamide, 2-ethylhexyl diphenyl phosphate, isodecyl diphenyl phosphate, tributyl phosphate, t-butylphenyl diphenyl phosphate, tricresyl phosphate, chloroparaffin 50% or 60% Cl, diethyl succinate, di-n-butyl maleate, di-(2-ethylhexyl) maleate, n-butyl stearate, acetyl triethyl citrate, triethyl citrate, tri-n-butyl citrate, acetyl tri-n-butyl citrate, methyl oleate, dibutyl fumarate, diisobutyl adipate, dimethyl azelate, epoxidized linseed oil, glycerol monooleate, methyl acetyl ricinloeate, n-butyl acetyl ricinloeate, propylene glycol ricinloeate, polyethylene glycol 200 dibenzoate, diethylene glycol dibenzoate, diprogylene glycol dibenzoate, dimethyl phthalate, diethyl phthalate, di-n-butylphthalate, diisobutyl phthalate, butyl benzyl phthalate, and glycerol triacetate. Of the preferred plasticizers, the more preferred comprise N-ethyl-o,p-toluenesulfonamide, t-butylphenyl diphenyl phosphate, tricresyl phosphate, chloroparaffin, 60% Cl, polyethylene glycol 200 dibenzoate, di-n-butylphthalate, and glycerol triacetate with the most preferred comprising diprogylene glycol dibenzoate, dimethyl phthalate, diethylene glycol dibenzoate, diethyl phthalate, butyl benzyl phthalate, diethyl succinate, and triethyl citrate.

The plasticizer compounds evaluated as described above and found to have a plasticizer effective amount with the AAPE used are shown in Table 2 wherein the plasticizer compounds are compatible plasticizers and are listed in descending order of effectiveness. Solubility also can be predicted using solubility parameter determinations as described by Michael M. Coleman, John E. Graf, and Paul C. Painter, in their book, Specific Interactions and the Miscibility of Polymer Blends, solubility values were ascribed to various plasticizers in the test. A solubility value can be ascribed to AAPE of copolyester of 45 mole % of terephthalic acid, 55 mole % adipic acid and essentially 100 mole % butanediol of 10.17. In one embodiment, a solubility value can be ascribed to a compatible plasticizer of this invention within a solubility value range of 8.17 to 12.17 (cal/cc)^{1/2}.

Evaluation of the experimental data by Coleman and others, with a comparison to solubility values of each plasticizer suggests that if a solvent/plasticizer falls within 2 (cal/cc)^{1/2} plus or minus of the value ascribed for the polymer, that the solvent/plasticizer will be compatible at some level with the polymer. Furthermore, the closer a plasticizer solubility values is to that of the AAPE copolyester, the more compatible it would be. However, solubility parameters are not absolute as that many forces are acting in conjunction when two molecules meet, especially as that the plasticizer/solvent is extremely small in comparison to the macromolecule of a polymer and simply that there are some that are not purely the named material. For instance, in the case of dipropylene glycol dibenzoate, the commercially prepared material may include levels of dipropylene glycol monobenzoate, propylene glycol dibenzoate and its monobenzoate as well as the potential for multiple polypropylene glycol groups. Additionally, a disadvantage of using the work presented by Coleman et al. is that some plasticizers contain end groups such as hydroxyl and metal ions and central elemental groups such as, phosphorus, sulfur, and other potential central elements that cannot be easily represented mathematically as that there is a lack of data on various solubility contributions by their work. Therefore, experimental data is needed to show potential of plasticization efficiency to a finer measure.

TABLE 2

| | | Temperature of Test (° C.) | | | | | | | |
|---|---|---|---|---|---|---|---|---|---|
| | δ(cal/cc)^{1/2} | 40 | 50 | 60 | 70 | 80 | 90 | 100 | 110 |
| N-Ethyl o,p-toluenesulfonamide | A | 5 | 7 | 7 | 7 | 7 | 7 | 7 | 7 |
| Dipropylene glycol dibenzoate | B | | 5 | 7 | 7 | 7 | 7 | 7 | 7 |
| Dimethyl phthalate | 10.4 | | | 7 | 7 | 7 | 7 | 7 | 7 |
| Diethylene glycol dibenzoate | 10.3 | | | 6 | 7 | 7 | 7 | 7 | 7 |
| t-Butylphenyl diphenyl phosphate | A | | | | | 7 | 7 | 7 | 7 |
| Tricresyl phosphate | A | | | | | 7 | 7 | 7 | 7 |
| Diethyl phthalate | 10 | | | | 6 | 7 | 7 | 7 | 7 |
| Butyl benzyl phthalate | 10.1 | | | | 5 | 7 | 7 | 7 | 7 |
| Chloroparaffin, 60% C1 | A | 5 | 6 | 6 | 6 | 6 | 7 | 7 | 7 |
| 2-Ethylhexyl diphenyl phosphate | A | | | | | 5 | 7 | 7 | 7 |
| Isodecyl diphenyl phosphate | A | | | | | | 7 | 7 | 7 |
| Polyethylene glycol 200 dibenzoate | 10.1 | | | | | | 7 | 7 | 7 |
| Di-n-butylphthalate | 9.5 | | | | | | 7 | 7 | 7 |
| Diethyl succinate | 9.2 | | | 6 | 6 | 6 | 6 | 7 | 7 |
| Chloroparaffin, 50% Cl | A | | | | | 6 | 6 | 7 | 7 |
| Di-n-butyl maleate | 8.9 | | | | | | 6 | 7 | 7 |
| Diisobutyl phthalate | 9.2 | | | | | | 6 | 7 | 7 |
| n-Butyl stearate | 8.2 | | | | | | | 7 | 7 |
| Dimethyl azelate | 9 | | | | 6 | 6 | 6 | 6 | 6 |
| Triethyl citrate | A | | | | | 5 | 6 | 6 | 6 |
| Glycerol triacetate | A | | | | | | 6 | 6 | 6 |
| Acetyl triethyl citrate | A | | | | | | | 6 | 6 |
| Tri-n-Butyl citrate | A | | | | | | | 6 | 6 |
| Tributyl phosphate | A | | | | | | | 6 | 6 |
| Di-(2-ethylhexyl) maleate | 8.7 | | | | | | | | 6 |
| Methyl oleate | B | | | | | | | | 5 |
| Dibutyl fumarate | 8.9 | | | | | | | 4 | 4 |
| Diisobutyl adipate | 8.6 | | | | | | | | 4 |
| Acetyl tri-n-butyl citrate | A | | | | | | | | 4 |
| Epoxidized linseed oil | B | | | | | | | | 4 |
| Glycerol monooleate | B | | | | | | | | 4 |
| Methyl acetyl ricinloeate | 8.7 | | | | | | | | 4 |
| n-Butyl acetyl ricinloeate | 8.6 | | | | | | | | 4 |
| Propylene glycol ricinloeate | A | | | | | | | | 4 |

A = Contains an element(s) that Coleman et al. had not given solubility constant in their work.
B = Contains a mixture of materials retained as a result of efficiency of production of the main plasticizer.

The invention has been described in detail with particular reference to preferred embodiments thereof, but it will be understood that variations and modifications can be effected within the spirit and scope of the invention.

1. A polymer composition comprising:
(A) a copolyester having a glass transition temperature of less than about 10° C. and comprised of:
(1) diacid residues comprising about 1 to 65 mole percent aromatic dicarboxylic acid residues; and 99 to about 35 mole percent of non-aromatic dicarboxylic acid residues selected from the group consisting of aliphatic dicarboxylic acids residues containing from about 4 to 14 carbon atoms and cycloaliphatic dicarboxylic acids residues containing from about 5 to 15 carbon atoms; wherein the total mole percent of diacid residues is equal to 100 mole percent; and
(2) diol residues selected from the group consisting of one or more aliphatic diols containing about 2 to 8 carbon atoms, polyalkylene ethers containing about 2 to 8 carbon atoms, and cycloaliphatic diols containing from about 4 to 12 carbon atoms; wherein the total mole percent of diol residues is equal to 100 mole percent; and
(B) a plasticizing effective amount of one or more compatible plasticizers.

2. The polymer composition of claim 1 comprising one or more plasticizers selected from the group consisting of acid residues, alcohol residues, benzoates, phthalates, phosphates or isophthalates.

3. The polymer composition of claim 2 wherein said acid residues comprise one or more residues selected from the group consisting of phthalic acid, adipic acid, trimellitic acid, benzoic acid, azelaic aid, terephthalic acid, isophthalic acid, butyric acid, glutaric acid, citric acid or phosphoric acid.

4. The polymer composition of claim 2 wherein said alcohol residues comprise one or more residues of an aliphatic, cycloaliphatic, or aromatic alcohol containing from 1 to 20 carbon atoms.

5. The polymer composition of claim 4 wherein said alcohol residues comprise one or more residues selected from the group consisting of methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1-4-cyclohexanedimethanol or diethylene glycol.

6. The polymer composition of claim 1 wherein said one or more plasticizers is selected from the group consisting of N-ethyl-o,p-toluenesulfonamide, 2-ethylhexyl diphenyl phosphate, isodecyl diphenyl phosphate, tributyl phosphate, t-butylphenyl diphenyl phosphate, tricresyl phosphate, chloroparaffin (60% chlorine), chloroparaffin (50% chlorine), diethyl succinate, di-n-butyl maleate, di-(2-ethylhexyl) maleate, n-butyl stearate, acetyl triethyl citrate, triethyl citrate, tri-n-butyl citrate, acetyl tri-n-butyl citrate, methyl oleate, dibutyl fumarate, diisobutyl adipate, dimethyl azelate, epoxidized linseed oil, glycerol monooleate, methyl acetyl ricinloeate, n-butyl acetyl ricinloeate, propylene glycol ricinloeate, polyethylene glycol 200 dibenzoate, diethylene glycol dibenzoate, dipropylene glycol dibenzoate, dimethyl phthalate, diethyl phthalate, di-n-butylphthalate, diisobutyl phthalate, butyl benzyl phthalate or glycerol triacetate.

7. The polymer composition of claim 6 wherein said plasticizer is selected from the group consisting of N-ethyl-o,p-toluenesulfonamide, 2-ethylhexyl diphenyl phosphate, isodecyl diphenyl phosphate, tributyl phosphate, t-butylphenyl diphenyl phosphate, tricresyl phosphate, chloroparaffin (60% chlorine), chloroparaffin (50% chlorine), diethyl succinate, di-n-butyl maleate, di-(2-ethylhexyl) maleate, n-butyl stearate, acetyl triethyl citrate, triethyl citrate, tri-n-butyl citrate, dimethyl azelate, polyethylene glycol 200 dibenzoate, diethylene glycol dibenzoate, dipropylene glycol dibenzoate, dimethyl phthalate, diethyl phthalate, di-n-butylphthalate, diisobutyl phthalate, butyl benzyl phthalate or glycerol triacetate.

8. The polymer composition of claim 7 wherein said one or more plasticizer(s) is selected from the group consisting of N-ethyl-o,p-toluenesulfonamide, 2-ethylhexyl diphenyl phosphate, isodecyl diphenyl phosphate, t-butylphenyl diphenyl phosphate, tricresyl phosphate, chloroparaffin (60% chlorine), chloroparaffin (50% chlorine), diethyl succinate, di-n-butyl maleate, n-butyl stearate, polyethylene glycol 200 dibenzoate, diethylene glycol dibenzoate, dipropylene glycol dibenzoate, dimethyl phthalate, diethyl phthalate, di-n-butylphthalate, diisobutyl phthalate or butyl benzyl phthalate.

9. The polymer composition of claim 8 wherein said one or more plasticizer(s) is selected from the group consisting of N-ethyl-o,p-toluenesulfonamide, 2-ethylhexyl diphenyl phosphate, isodecyl diphenyl phosphate, t-butylphenyl diphenyl phosphate, tricresyl phosphate, chloroparaffin (60% chlorine), polyethylene glycol 200 dibenzoate, diethylene glycol dibenzoate, dipropylene glycol dibenzoate, dimethyl phthalate, diethyl phthalate, di-n-butylphthalate or butyl benzyl phthalate.

10. The polymer composition of claim 9 wherein said one or more plasticizer(s) is selected from the group consisting of N-ethyl-o,p-toluenesulfonamide, t-butylphenyl diphenyl phosphate, tricresyl phosphate, diethylene glycol dibenzoate, dipropylene glycol dibenzoate, dimethyl phthalate, diethyl phthalate or butyl benzyl phthalate.

11. The polymer composition of claim 10 wherein said one or more plasticizer(s) is selected from the group consisting of N-ethyl-o,p-toluenesulfonamide, diethylene glycol dibenzoate, dipropylene glycol dibenzoate, or dimethyl phthalate.

12. The polymer composition of claim 11 wherein said plasticizer(s) comprises diethylene glycol dibenzoate.

13. A polymer composition according to claim 1 wherein polyester (A) comprises diacid residues are selected from the group consisting of terephthalic acid, isophthalic acid, or mixtures thereof.

14. A polymer composition according to claim 1 wherein polyester (A) comprises about 25 to 65 mole percent of terephthalic acid residues.

15. A polymer composition according to claim 14 wherein polyester (A) comprises about 35 to 65 mole percent of terephthalic acid residues.

16. A polymer composition according to claim 15 wherein polyester (A) comprises about 40 to 60 mole percent of terephthalic acid residues.

17. A polymer composition according to claim 1 wherein the non-aromatic dicarboxylic acid residues are selected from the group consisting of adipic acid, glutaric acid or mixtures thereof.

18. A polymer composition according to claim 17 wherein polyester (A) comprises about 75 to 35 mole percent of non-aromatic dicarboxylic acid(s) selected from the group consisting of adipic acid, glutaric acid, or mixtures thereof.

19. A polymer composition according to claim 18 wherein the polyester (A) comprises about 65 to 35 mole percent of non-aromatic dicarboxylic acid(s) selected from the group consisting of adipic acid, glutaric acid, or mixtures thereof.

20. A polymer composition according to claim 19 wherein the polyester (A) comprises about 40 to 60 mole percent of non-aromatic dicarboxylic acid(s) selected from the group consisting of adipic acid, glutaric acid, or combinations of two or more diol residues thereof.

21. A polymer composition according to claim 1 wherein the diol residue(s) of polyester (A) are selected from the group consisting of ethylene glycol, diethylene glycol, propylene glycol, 1,3-propanediol, 2,2-dimethyl-1,3-propanediol, 1,3-butanediol, 1,4-butanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, triethylene glycol, and tetraethylene glycol or combinations of two or more diol residues thereof.

22. A polymer composition according to claim 1 wherein the diol residues of polyester (A) consist essentially of aliphatic diol residues.

23. A polymer composition according to claim 22 wherein polyester (A) comprises diol(s) selected from the group consisting of 1,4-butanediol, 1,3-propanediol, ethylene glycol, 1,6-hexanediol, diethylene glycol, 1,4-cyclohexanedimethanol or combinations of two or more diol residues thereof.

24. A polymer composition according to claim 22 wherein polyester (A) comprises diol(s) selected from the group consisting of 1,4-butanediol, ethylene glycol, 1,4-cyclohexanedimethanol or combinations of two or more diol residues thereof.

25. A polymer composition according to claim 24 wherein the diol residues of polyester (A) comprise 1,4-butanediol.

26. A polymer composition according to claim 25 wherein polyester (A) comprises diol residues further comprising about 80 to 100 mole percent of 1,4-butanediol; wherein the total mole percent of diol residues is equal to 100 mole percent.

27. A polymer composition according to claim 1 wherein the diacid and diol residues of polyester (A) consist essentially of:
(1) aromatic dicarboxylic acid residues comprising about 25 to 65 mole percent of terephthalic acid residues and 75 to about 35 mole percent non-aromatic dicarboxylic acid residues; and
(2) diol residues consisting of aliphatic diols.

28. A polymer composition according to claim 27 wherein the diacid and diol residues of polyester (A) consist essentially of:
(1) aromatic dicarboxylic acid residues comprising about 25 to 65 mole percent of terephthalic acid residues and 75 to about 35 mole percent of adipic acid residues, glutaric acid residues, or combinations of adipic acid residues and glutaric acid residues; and
(2) diol residues consisting of 1,4-butanediol.

29. A polymer composition according to claim 28 wherein the diacid and diol residues of polyester (A) consist essentially of:
(1) aromatic dicarboxylic acid residues comprising about 35 to 65 mole percent of terephthalic acid residues and 65 to about 35 mole percent of adipic acid residues, glutaric acid residues, or combinations of adipic acid residues and glutaric acid residues; and
(2) diol residues consisting of 1,4-butanediol.

30. A polymer composition according to claim 29 wherein the diacid and diol residues of polyester (A) consist essentially of:
(1) aromatic dicarboxylic acid residues comprising about 40 to 60 mole percent of terephthalic acid residues and 60 to about 40 mole percent of adipic acid residues, glutaric acid residues, or combinations of adipic acid residues and glutaric acid residues; and
(2) diol residues consisting of 1,4-butanediol.

31. A polymer composition according to claim 1 wherein polyester (A) an inherent viscosity (I.V.) of about 0.4 to 2.0 dL/g as determined at 25° C. using 0.50 gram of polymer per 100 mL of a solvent composed of 60 weight percent phenol and 40 weight percent tetrachloroethane.

32. A polymer composition according to claim 1 wherein the total weight percent of the plasticizer is from about 5 to 40 weight percent and the weight percent of polyester (A) is from about 95 to 60 weight percent, wherein the total weight percent of said plasticizer and polyester (A) is equal to 100 weight percent.

33. A polymer composition according to claim 32 wherein the total weight percent of the plasticizer is from about 5 to 20 weight percent and the weight percent of polyester (A) is from about 80 to 95 weight percent, wherein the total weight percent of said plasticizer and polyester (A) is equal to 100 weight percent.

34. A polymer composition according claim 33 wherein the polyester (A) comprises component (C) which further comprises one or more phosphorus catalyst quenchers which provide an elemental phosphorus concentration of about 0 to 0.5 weight percent based on the weight of components (A) and (B).

35. The polymer composition of claim 1 wherein polyester (A) comprises one or more branching agents comprising about 0.01 to about 10.0 weight percent, based on the total weight of polyester (A).

36. The polymer composition of claim 35 containing one or more branching agents comprising about 0.05 to about 5 weight percent, based on the total weight of polyester (A).

37. The polymer composition of claim 36 wherein said branching agents comprise one or more residues of monomers having 3 or more carboxyl substituents, hydroxyl substituents, or a combination thereof.

38. The polymer composition of claim 37 wherein said branching agents comprise one or more residues of: trimellitic anhydride, pyromellitic dianhydride, glycerol, sorbitol, 1,2,6-hexanetriol, pentaerythritol, trimethylolethane, or trimesic acid.

39. The polymer composition of claim 1 comprising about 5 to about 40 weight %, based on the total weight of said polymer composition, of a flame retardant.

40. The polymer composition of claim 39 comprising one or flame retardants selected from the group consisting of phosphorous based compounds.

41. The polymer composition of claim 40 comprising one or more monoesters, diesters, or triesters of phosphoric acid.

42. A process for the manufacture of film or sheet or molded object comprising the steps of extruding or calendering or injection molding a polymer composition according to claim 1.

43. A film or sheet or molded object comprising a polymer composition according to claim 1.

44. A film or sheet or molded object according to claim 42 wherein said film or sheet was produced by extrusion or calendering.

45. A molded object comprising a polymer composition according to claim 1.

46. The polymer composition of claim 1 wherein the solubility of said plasticizer falls within plus or minus 2 (cal/cc)^{1/2} of the solubility value of the polyester itself.

47. The polymer composition of claim 46 wherein the solubility of said plasticizer falls within plus or minus 1.5 (cal/cc)^{1/2} of the solubility value of the polyester itself.

48. The polymer composition of claim 47 wherein the solubility of said plasticizer falls within plus or minus 1 (cal/cc)^{1/2} of the solubility value of the polyester itself.

49. The polymer composition of claim 1 wherein polyester (A) is a copolyester comprising 45 mole % of terephthalic acid residues, 55 mole % of adipic acid and consisting essentially of 100 mole % 1,4-butanediol and wherein the solubility of said plasticizer falls within a solubility value range of 8.17 to 12.17 (cal/cc)^{1/2}.
